(19) United States
(12) Patent Application Publication
(10) Pub. No.: US 2002/0093407 A1
(43) Pub. Date: Jul. 18, 2002

(54) Magnetic switch

(76) Inventor: Don Harris, Davenport, CA (US)

Correspondence Address: Jeffrey A. Hall, 212 Clinton Street, Santa Cruz, CA, 95062, US

(21) Appl. No.: 09/764,188

(22) Filed: Jan. 16, 2001

(51) Int. Cl. H01H 9/00

(52) U.S. Cl. 335/207

(57) ABSTRACT

A magnetic switch, comprising a first pair of magnets, a pivot element secured to the first pair of magnets, and a metallic element secured to the pivot and in operably proximity to the first pair of magnets. A first pair of metallic elements is positioned in operably proximity to the first pair of magnets and a second pair of magnets is in operably proximity to the first pair of metallic elements and to a metallic base.

### BACKGROUND OF THE INVENTION

1. Field of Invention

This invention relates to magnetic switches, and in particular to magnetic switches where full flux density is contained within the switch and where the rotation of a pair of magnets allows the flux density to vary from null to full strength or points in between.

2. Description of the Related Art

Heretofore a wide variety of magnetic switches have been proposed and implemented. Such switches have been limited in applicability due to inefficiencies, cumbersomeness, and expense. The present invention provides a simple yet highly efficient magnetic switch which can be easily and efficiently implemented in a wide variety of applications.

The magnetic switch of the present invention may be used in any application where a strong magnet or magnetic force is needed which can be easily turned on and off. It is further very useful in any application where a magnet is need where the flux density must be varied easily and exactly in a range from full to null, and may be efficiently used in alternators and motors.

Accordingly, it is the primary object of this invention to provide a controllable magnetic switch which is configured so as to allow full magnetic flux density to be contained within the switch, and by rotation of magnets about an axis, allows full flux density across two exposed metallic elements. By rotating the positioned magnets from one setting to another, flux density will go from null to full, or any intermediate setting as desired.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### BRIEF SUMMARY OF THE INVENTION

The present invention is a controllable magnetic switch which allows the full magnetic flux density to be contained within the switch when inactivated, and with a single rotation of a pivot, allows full flux density across two magnetic pieces.

To achieve the foregoing objects, and in accordance with the purpose of the invention as embodied and broadly described herein, a magnetic switch is provided, comprising a first pair of magnets, a pivot element secured to the first pair of magnets, and a metallic element secured to the pivot and in operably proximity to the first pair of magnets. A first pair of metallic elements is positioned in operably proximity to the first pair of magnets and a second pair of magnets is in operably proximity to the first pair of metallic elements and to a metallic base. The magnetic switch allows full flux density to be contained within the switch and repositioning of the flux density across exposed iron elements. by rotating the magnets from one setting to another, flux density will go from null to full or at any strength in-between as desired.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a magnetic switch, according to the invention.

FIG. 2A is such magnetic switch in an “on” or externally magnetic orientation, according to another embodiment of the invention.

FIG. 2B shows schematically the flux path when such switch is in an “on” orientation, according to the invention.

FIG. 3A shows such magnetic switch in an “off” or externally non-magnetic orientation, according to the invention.

FIG. 3B is a schematic representation of such switch in the “off” orientation showing the flux path, according to the invention.

### DETAILED DESCRIPTION OF THE INVENTION

Reference will now be made in detail to the present preferred embodiments of the invention as illustrated in the accompanying drawings.

In accordance with the present invention, there is provided a magnetic switch, comprising a first pair of magnets, a pivot element secured to the first pair of magnets, and a metallic element secured to the pivot and in operably proximity to the first pair of magnets. A first pair of metallic elements, or a single piece magnetic element is preferably positioned in operably proximity to the first pair of magnets and a second pair of magnets is in operably proximity to the first pair of metallic elements and to a metallic base.

In FIG. 1, magnetic switch 10 is shown according to a preferred embodiment of the invention. Preferably, magnetic switch 10 comprises a first pair of magnets 12, preferably rare earth magnets, and pivot means 14 operably positioned in proximity to metallic element 16. Pivot means 14 may be mechanical pivot such as a shaft, rod, pivot, or the like of non-magnetic material. Alternativley pivot 14 may be electronically or magnetically controlled. Metallic element 16, which is preferably composed of iron, is operably positioned in proximity to the first pair of magnets 16. A metallic element or pair of magnetic elements 18 function as a pole piece and are operably positioned in proximity to the first pair of magnets 12 and to a second pair of magnets 20. Base 22 is composed of a metal, preferably iron. Space 21 is preferably oriented vertically in relation to base 22 and metallic element 16.

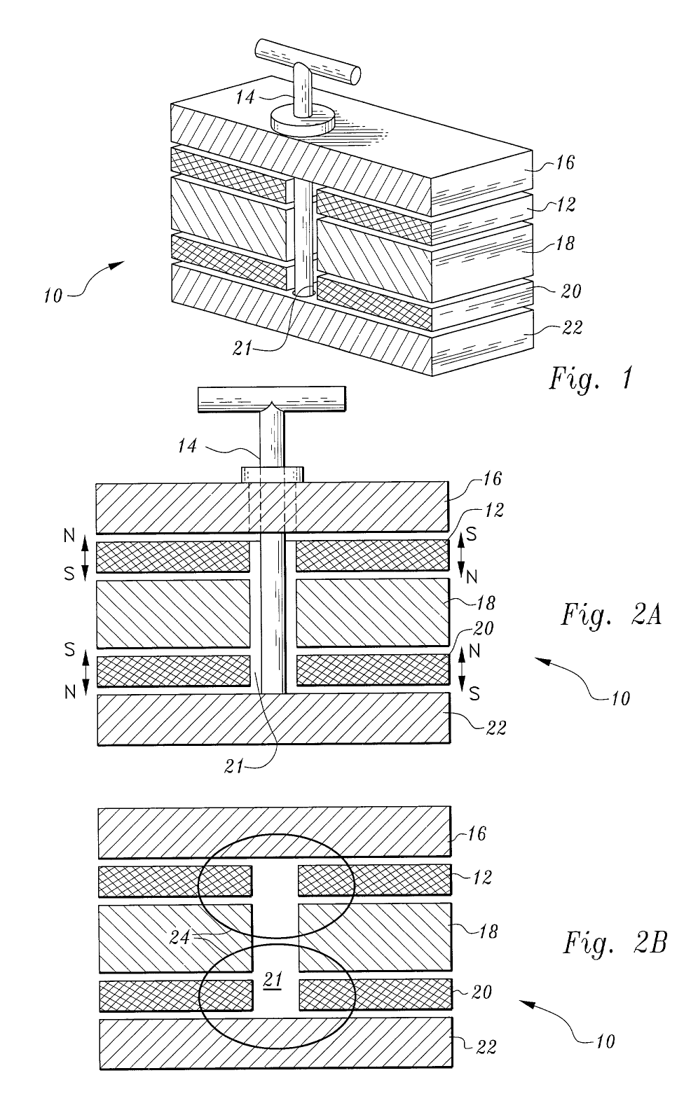

With reference now to FIG. 2A, magnetic switch 10 is shown with the positions and magnetic orientations of first pair of magnets 12, and second pair of magnets 20, when the magnetic switch is in an “on” position, that is, externally magnetic.

Referring to FIG. 2B, the flux path 24 is illustrated when magnetic switch 10 is in an “on” orientation and externally magnetic.

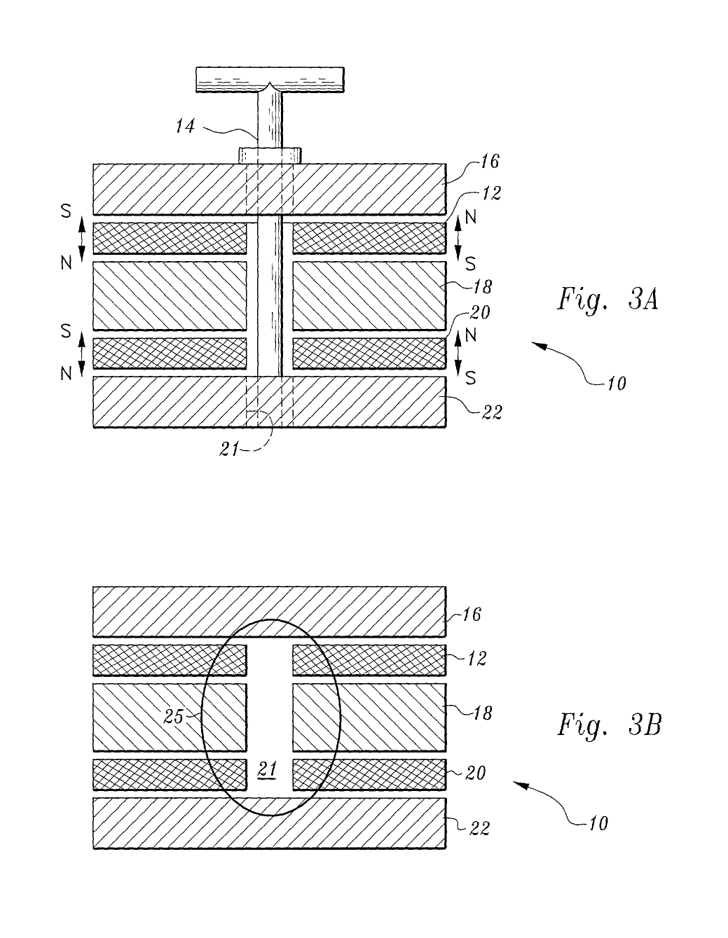

In FIG. 3A, magnetic switch 10 is shown with the positions and magnetic orientations of first pair of magnets 12 and second pair of magnets 20 when the magnetic switch is in an “off” position, that is, externally non-magnetic.

In FIG. 3B, the flux path 25 is illustrated when magnetic switch 10 is in an “off” orientation and externally non-magnetic.

In operation and use magnetic switch 10 is extremely useful, efficient and inexpensive to manufacture. The configuration and orientation of the magnets and metallic elements allow for full magnetic flux density to be contained within the switch and with one half rotation or 180 degree rotation of pivot 14 about its axis, changed to allow full flux density across two exposed metallic pieces. By rotation the magnets from one setting to another, flux density will vary from null to full, or any density in-between.

The magnetic switch 10, of the present invention may be turned completely off in the null position unlike other circuits using iron shunting. Further the entire surface of the magnetic switch is available for magnetization, resulting in substantially higher flux density, i.e. stronger magnetism, for a given size switch.

Magnetic switch 10, lends itself to multiple applications such as alternator rotors, where high flux density is critical. With magnetic switch 10, the flux path in null and partial settings remains within the switch and across the active metallic elements, resulting in increased efficiency in applications, such as alternators, where stray magnetism results in loss of efficiency.

As is evident from the above description, a wide variety of magnetic switches may be configured using the magnetic switch described herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A magnetic switch, comprising:
a first pair of magnets;
pivot means secured to said first pair of magnets;
a metallic element, said metallic element being secured to said pivot means and in operably proximity to said first pair of magnets;
a first pair of metallic elements, said first pair of metallic elements being positioned in operably proximity to said first pair of magnets; and
a second pair of magnets, said second pair of magnets being in operably proximity to said first pair of metallic elements and to a metallic base.

2. The magnetic switch of claim 1, wherein said first pair of magnets are rare earth magnets.

3. The magnetic switch of claim 1, wherein said second pair of magnets are rare earth magnets.

4. The magnetic switch of claim 1, wherein said pivot means comprises a non-magnetic pivot.

5. A controllable magnetic switch, comprising:
a first pair of rare earth magnets;
pivot means secured to said first pair of rare earth magnets;
a metallic element, said metallic being secured to said pivot means and in operably proximity to said first pair of rare earth magnets;
a first metallic element, said metallic element being positioned in operably proximity to said first pair of rare earth magnets; and
a second pair of rare earth magnets, said second pair of rare earth magnets being in operably proximity to said first pair of metallic elements and to a metallic base.

6. The controllable magnetic switch of claim 5, wherein said pivot means comprises a non-magnetic pivot.
